(19) United States
(12) Patent Application Publication
(10) Pub. No.: US 2014/0031084 A1
(43) Pub. Date: Jan. 30, 2014

(54) Print and Electronic Greeting Card/Announcement Telephony Integration System and Method

(71) Applicant: Alan W. Johnson, JR., Denver, CO (US)

(72) Inventor: Alan W. Johnson, JR., Denver, CO (US)

(21) Appl. No.: 13/949,957

(22) Filed: Jul. 24, 2013

Related U.S. Application Data
(60) Provisional application No. 61/675,090, filed on Jul. 24, 2012.

(51) Int. Cl. H04M 1/725

(52) U.S. Cl. CPC H04M 1/72519
USPC 455/564

(57) ABSTRACT

A greeting card system and method for bringing a personal connection. Generally, the greeting card, which can be either a printed card or an electronic card (i.e., an e-card) is configured to connect at least two phone numbers when activated. The method includes obtaining a desired card which is capable of being configured for a telephony connection, configuring the card, delivering the card, activating the card, and connecting the at least two telephone numbers. Electronics are connected to the printed card, or operations are provided in the electronic card, with at least two phone numbers being connected upon activation. Further still, a triggering device is preferably used for activating the configured electronics and the configured operations of the e-card.

### RELATED APPLICATIONS

This application claims the filing priority of U.S. Provisional Application No. 61/675,090 titled “Print And Electronic Greeting Card/Announcement Telephony Integration System And Method” and filed on Jul. 24, 2012. The '090 provisional application is hereby incorporated by reference.

Additionally, this application hereby incorporates by reference U.S. Patent Publication Nos. 2010/0175287 and 2003/0150141 and U.S. Pat. Nos. 7,058,365, 5,592,537 and 6,061,580.

### TECHNICAL FIELD

The system and method of the present application relates to greeting cards and particularly greeting cards, electronic and printed, which allow the sender to deliver a personalized message.

### BACKGROUND OF THE INVENTION

Greeting cards are a multi-billion dollar industry. The number of occasions for sending a greeting card expands almost every year. While at one time birthdays, weddings, anniversaries and certain holidays (e.g., Christmas) may have accounted for the vast majority of card buying and sending, special occasion cards (e.g., get well, thank you, Valentine's Day, etc.) have increased the popularity of greeting cards. Likewise, creation of the electronic greeting card, which can be quick and simple to create, less expensive to obtain (in some cases free), and is often times more personal, has resulted in a great increase in greeting card exchanges.

However, regardless of the ability to “personalize” the message in print and electronic greeting cards, the cards still lack a personal connection between the sender and receiver. The personal connection can take greeting cards

The present systems and methods solve these and other problems associated with traditional greeting cards, including printed and electronic cards, by providing the ability to personally connect a sender and a receiver. Many of the problems associated with present greeting cards and sending practices have gone unrecognized or unappreciated by those skilled in the art, leaving solutions and improvements to be overlooked.

### SUMMARY OF THE INVENTION

A greeting card system and method for bringing a personal connection is set forth. Generally speaking, the greeting card, which can be either a printed card or an electronic card (i.e., an e-card) is configured to connect at least two phone numbers when activated. The different features disclosed may be included in any reasonable combination to effect the different embodiments, some of which are explicitly disclosed while others are implicit, as would be understood by one skilled in the art.

In a general embodiment, the method for connecting at least two telephone numbers through use of a personalized greeting card comprises the steps of obtaining a desired greeting card which is capable of being configured for providing a telephony connection, configuring the greeting card to connect at least two telephone numbers when activated, delivering the greeting card to a desired recipient, activating the greeting card to carry out the configured connection, and connecting the at least two telephone numbers.

In a specific embodiment, the desired greeting card comprises a printed greeting card having electronics thereon, the electronics being capable of configuration to connect at least two telephone numbers when activated. The electronics are preferably activated by the step of opening the card. However, the electronics may be activated by the step of pushing a button electronically coupled to the configured electronics.

In other specific embodiments, the greeting card comprises an electronic greeting card, such as created or otherwise obtained online. In embodiments, the step of activating comprises the step of clicking a mouse button on the card. Further, the card may be reconfigured for reuse.

Generally speaking, the disclosed greeting card comprises one of either a printed card having at least a front and rear face for carrying a message, or an electronic card. In embodiments of each, electronics are connected to the printed card, or operations are provided in the electronic card, wherein at least two phone numbers are connected upon activation. Further still, a triggering device is preferably used for activating the configured electronics and the configured operations of the e-card.

These and other features of the inventive system and controller will be more readily apparent from a review of the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a simplified flow diagram of an embodiment of the present method; and

FIG. 2 is a simplified illustration of an embodiment of the present system.

### DETAILED DESCRIPTION OF PREFERRED EMBODIMENT(S)

While this invention is susceptible of embodiments in many different forms, there is shown in the drawings, and will herein be described in detail, at least one preferred embodiment of the invention with the understanding that the present disclosure is to be considered as an exemplification of the principles of the invention and is not intended to limit the broad aspect of the invention to any of the specific embodiments illustrated.

The general purpose of the system and methods is to provide printed greeting cards and electronic/internet-based greeting cards/messages that integrate the card with specific telephony functions to either: (1) create a live telephony connection between two or more telephone numbers, or (2) leave a personalized message. Using such a system, any person can purchase and send a printed card or an electronic greeting card/message that performs a telephony integration to connect two or more telephone numbers when opened or otherwise activated.

By “greeting card” it is meant any type of card exchanged between a sender and a recipient, including but not limited to holiday, religious, birthday, anniversary, special events, romantic, get-well, thank you, cultural events, invitations, and the like. Further, the term “sending” is intended to include physical delivery of a printed card by any means, as well as electronic delivery of a card, including sending an email or text with a link to a prepared card.

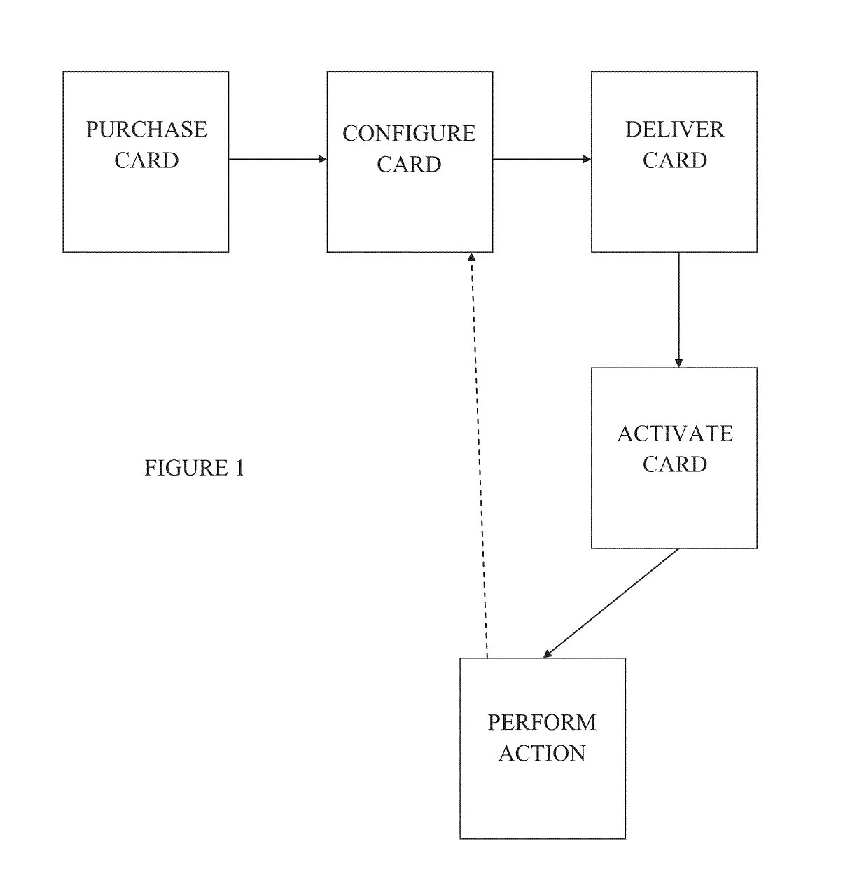

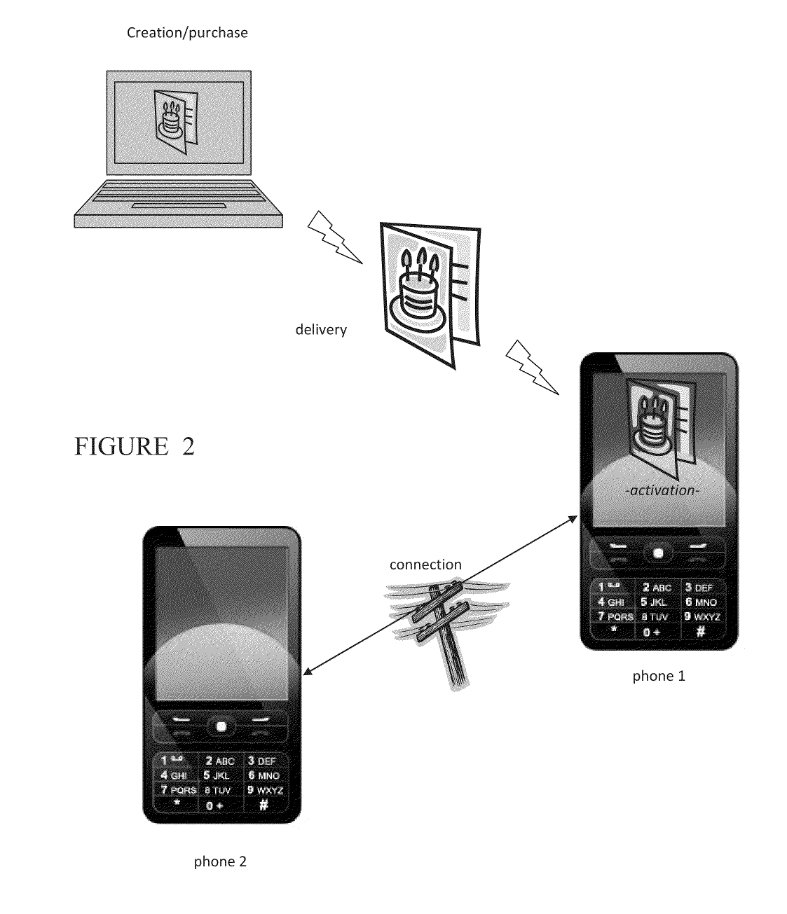

A simplified embodiment of the process of the present system and method is illustrated in FIGS. 1 and 2. Initially, a customer purchases either a printed greeting card with electronic technology or an electronic greeting card from an Internet website. In either case, the card is to be capable of configuration by the purchaser. As shown by the dashed line in FIG. 1, the system may permit electronics to be reused/recycled from a previous purchase or card receipt, if desired. The number of reuses may or may not be limited. In the next step, the customer either configures the electronics technology within the card for the telephony connection or goes to online/website/app location to configure the connection process(es). The electronics may be configured at the card purchase site (e.g., store or website), a designated kiosk, from a home/work computer, or from a personal smart phone app.

When configuring the electronics directly or using a website/app/online method to configure the connection, the purchaser may need to enter specific information. For example, in an embodiment the information may include the following:
a. a ‘card identification’ number;
b. a first telephone number (target) to call;
c. a second or subsequent telephone numbers(s) to call;
d. any additional telephone numbers to call;
e. a call order or hierarchy;
f. an originating call number;
g. the number of calls/minutes/contacts to be purchased;
h. a personal message to leave (e.g., may be typed and/or voice-recorded);
i. contact information for purchaser, call originator and call target(s);
j. network connection information such as phone carrier network, user name, password, etc.;
k. any bridge connection devices, as necessary;
l. an activation code for the card; and
m. payment information (e.g., credit card, paypal account, etc.).

Certainly, other message information or data (especially in an electronic card example) may be requested and input. Such additional information may include a delivery date and time, introductory music (selected from a menu of options or downloaded), reoccurring (e.g., birthday) or single time (e.g., get well) delivery, and numerous other possible options.

Once delivered to the intended recipient, the card may then be activated. In an embodiment of this process, the purchaser/customer delivers the card to the recipient. This may be accomplished by physically handing the desired recipient the printed card (or sending it through the U.S. mail or a similar delivery service), or the electronic card/message may be delivered via email or a link sent by email or via an electronic text message. The recipient then is able to view and activate the card as configured.

Activation to trigger a call can occur either (1) once the card is opened by the recipient, or (2) upon pushing a button, clicking a mouse, or any other known method for activating an electronic device. The activation may be a surprise to the recipient or known to allow for scheduling the connection.

Upon activation, electronics technology within the printed card or the electronic card itself performs an electronic connection such as an http post, internet carried communication or other type of electronic, Bluetooth or cellular communication to a connection service directly or through a bridging device, as configured.

The connection service performs the process actions as configured. These actions may include tracking the call against a specified account, making an initial call, delivering a first message and requesting a key-press (if desired), making a second and subsequent calls, delivering the inputted message, or, of course, allowing for a live telephone call between two or more parties.

The greeting card electronics technology is preferably comprised of a small electronics attachment within the card. This electronics of the card performs the triggering action that initiates the configuration connection service to make the telephone calls. It may contain any number or reasonable combination of the following features:
a. battery powering;
b. identifying serial number or information within electronics or printed on the technology or card;
c. portable/reusable/recyclable;
d. wireless connectivity, as an example, can be achieved through an embodiment of the following methods:
   i. standard wireless connectivity;
   ii. Internet carried connectivity;
   iii. Bluetooth™;
   iv. radio;
   v. television remote; and
   vi. card to app connectivity or other bridging device/service;
e. connectivity may be bridged from another device, such as:
   i. iOS, Android or other portable internet connection and service app (via wireless or wired connection); or
   ii. TV, game console, or Internet attached device.

In a specific embodiment, the electronics within the printed card may perform any number or reasonable combination of the following features:
a. a switch for activating the card to make the connection (opening the card, pressing a button, moving a switch);
b. establishes a connection to the connection service via a connectivity method or bridging through another Internet connected device;
c. acts directly as the connection service;
d. posts an http:// request or other request to the connection service; and
d. other potential items like displaying status, lighting up lights, or playing music or some other features for the card.

Upon the receipt of the initiation of the service from a greeting card, the backend telephony technology handles the logic and connections to make the telephone calls based upon the customer's preferences and configuration. For example, in a specific embodiment the telephony connection services could exist on multiple platforms and could originate calls using the technology and methods available on those platforms. In another embodiment, platforms for the telephony connection service could be website/web-server application on the Internet or electronics within the telephony greeting card itself. Finally, an app (or application) running on iOS, Android, MacOS, Windows, Linux or other known operating platform that acts either as a bridge or acts as the primary connection service may be used.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for providing a connection between at least two telephone numbers through use of a personalized greeting card, the method comprising the steps of:
obtaining a desired greeting card which is capable of being configured for providing a telephony connection;
configuring the greeting card to connect at least two telephone numbers when activated;
delivering the greeting card to a desired recipient;
activating the greeting card to carry out the configured connection; and
connecting the at least two telephone numbers.

2. The method of claim 1, wherein the desired greeting card comprises a printed greeting card having electronics thereon, the electronics being capable of configuration to connect at least two telephone numbers when activated.

3. The method of claim 2, wherein the electronics are activated by the step of opening the card.

4. The method of claim 2, wherein the electronics are activated by the step of pushing a button electronically coupled to the configured electronics.

5. The method of claim 1, wherein the greeting card comprises an electronic greeting card.

6. The method of claim 5, wherein the step of activating comprises the step of clicking a mouse button on the card.

7. The method of claim 1, further comprising the step of reconfiguring the greeting card for reuse.

8. The method of claim 7, wherein the step of reconfiguring comprises the step of changing the at least two phone numbers to be connected.

9. The method of claim 1, wherein the step of configuring the greeting card comprises the step of inputting to a central system, information on at least one phone number to call, an originating phone number, and a card identification number.

10. The method of claim 1, wherein the step of connecting comprises the step of achieving at least one of the following: an http post, an Internet carried communication, a Bluetooth communication, and a cellular communication.

11. A greeting card comprising:
a printed card having at least a front and rear face for carrying a message;
electronics connected to the printed card, wherein the electronics are configured to connect at least two phone numbers upon activation;
a triggering device for activating the configured electronics.

12. The greeting card of claim 11, wherein the electronics are battery powered and reusable.

13. The greeting card of claim 11, wherein the electronics comprise wireless connectivity.

14. The greeting card of claim 11, wherein the triggering device comprises opening a page of the card.

15. The greeting card of claim 11, wherein the triggering device comprises pushing a button on the electronics.

16. The greeting card of claim 12, wherein the electronics can be reconfigured to connect at least two phone numbers upon activation.
